(19) United States
(12) Patent Application Publication
(10) Pub. No.: US 2006/0017542 A1
(43) Pub. Date: Jan. 26, 2006

(54) Short range wireless RFguest pager system with removable memory providing displayed ancillary information for making waiting in line more tolerable and productive

(75) Inventors: Lane Thomas Holloway, Pflugerville, TX (US); Walid M. Kobrosly, Round Rock, TX (US); Nadeem Malik, Austin, TX (US)

Correspondence Address: Mark E. McBurney;International Business Machines Corporation, Intellectual Property Law Dept., Internal Zip 4054, 11400 Burnet Road, Austin, TX, 78758, US

(73) Assignee: International Business Machines Corporation, Armonk, NY (US)

(21) Appl. No.: 10/897,229

(22) Filed: Jul. 22, 2004

(51) Int. Cl. H04Q 7/14; G08B 5/22

(52) U.S. Cl. 340/7.55; 340/7.52

(57) ABSTRACT

An implementation for giving the guest carrying the pager ancillary information in a short range guest pager system, including a localized short range RF transmitter and portable wireless receiving pager with an activatable page indicator. The implementation comprises a pager housing supporting the pager indicator adapted to receive removable memory means in which the ancillary information is stored. There is a display in the housing with interactive user input means to the pager for selectively activating the display of the ancillary information, and display controller means in said housing for controlling said display of this ancillary information.

### TECHNICAL FIELD

The present invention relates to computer controlled consumer electronics devices or instruments, and particularly to short range wireless RF guest pagers used in restaurants, hotels, government agencies, tickets sales and like events where customers must wait in line for service.

### BACKGROUND OF RELATED ART

The past decade has been marked by a technological revolution driven by the convergence of the data processing industry with the consumer electronics industry. The effect has, in turn, driven consumer electronics technologies that have been known and available but relatively quiescent over the years to now come into great demand in the marketplace.

The rapid expansion in the capacity of computers to perform support functions, the greater and greater miniaturization of computers, as well as reduction in costs to perform memory and computer operations has opened the door for computer controller consumer instrumentation. A key aspect of this expansion has been lower and lower cost memory. In recent years, this has been manifested in flash memory cards and sticks. At the current technology stage, these memory cards and sticks are detachably inserted into the computer controlled electronic instruments to provide an extra memory capacity of from one half to four to five gigabytes. Memory cards use a flash memory that is based upon EEPROM (electrically erasable programmable read only memory) grid chips. Flash memory EEPROM works much faster than conventional EEPROM. Instead of erasing one byte at a time, it erases an entire block or an entire chip at a time and then rewrites. Smartmedia and Compactflash provide the “electronic film” for digital cameras, while the Sony memory stick is quite popular in digital cameras and for computer controlled video games. These high capacity memory cards and sticks have been performing hard drive storage function for the above-described computer controlled electronic instruments. In this connection, the SSFDC (solid state floppy disc card) developed by Toshiba Inc. may function as the above-described Smartmedia card. Similarly, the above-referenced CompactFlash is a small circuit board with at least one flash memory chip and a dedicated controller chip encased in a housing or shell.

This rapid rise in the memory capacity to cost ratios has led to widespread usage of detachable memory cards in many consumer areas. The present invention provides a new application directed to a problem that is clearly on the increase in our society: the oft dreaded, “WAITING IN LINE”.

In order to fully comprehend the sociopolitical implications of this problem, a brief simplified review of its history is in order. As we all know, World War II was fought to preserve what President Franklin D. Roosevelt called the “Four Freedoms: Speech, Religion, from Want and Fear.” However, for the “Greatest Generation” of almost 20 million Americans who returned from years and years of war that often involved the tedium of waiting, there was a definite and sincere but humorously described demand for a Fifth Freedom: from standing in line. Thus, during the next 40 years after World War II, there was a byline: “Don't keep the customer waiting.”

During the same time periods, in the Communist East, life was consumed with “Waiting In Line”. In these bureaucracies, the people had to wait in line for most things consumable and for permission to make virtually every decision required in life. If fact, most historical pundits are likely to concede that the “Cold War” was lost by the East not so much because of the lack of freedom to speak out by their citizens but by the intolerable and interminable waiting in line that their citizens faced day in and day out.

So why is this significant to the present invention? Over the past 15 to 20 years, there has been an increasing imposition of “Waiting in Line” upon our consuming public. The ever increasing emphasis on productivity, cutting staffs and outsourcing of functions, has brought about a significant reduction in service offered to the public in all aspects and levels of industry, commerce and government. This has resulted in longer periods of waiting in line in all of these areas.

Faced with this problem, industry and commerce are seeking and have found implementations for making waiting in line less tedious. A substantial advance in this direction has been the guest or restaurant type pager. This pager is a small handheld one frequency wireless RF receiver to which a short range RF transmitter in the restaurant, hotel or like facility broadcasts a signal that triggers flashing lights and/or a buzzer in the receiver device telling the customer or client waiting in line that his turn has been reached. Such an arrangement avoids the physical discomfort and strain of actually standing in line but it still does not avoid the wasted unproductive time spent in waiting.

### SUMMARY OF THE PRESENT INVENTION

That is where the present invention comes in. The invention provides an implementation for giving the guest carrying the pager ancillary information in a short range guest pager system including a localized short range RF transmitter and the portable wireless receiving pager. The implementation comprises a pager housing supporting the pager indicator adapted to receive removable memory means in which the ancillary information is stored. There is a display in the housing with interactive user input means to the pager for selectively activating the display of the ancillary information, and display controller means in said housing for controlling this display of this ancillary information. This ancillary information may, for example, be menu and food description data in a restaurant page system, accommodations and hotel facilities and amenities in a hotel checking system, explanations of applicable rules and regulations where the pager system is at a government facility, such as a tax or licensing office or court, or on available tickets at a show or sports ticketing facility.

The display screen is most appropriately a liquid crystal display (LCD) of the type now extensively used in cellular telephones and in wireless handheld computers. As will be hereinafter described in greater detail, the handheld pager is readily modifiable to include such a display. Actually, the LCD may be a touch screen type of LCD display, in which case the input may be with a finger or stylus.

The removable memory means may be a programmable memory card, such as flash memory card or a memory stick popular with digital cameras. Very good results are achieved when the housing includes a USB I/O slot and the removable memory stick is inserted into said USB I/O slot.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a diagrammatic illustration of a guest pager system in accordance with the present invention, particularly illustrating the memory card providing the required storage and the LCD screen;

FIG. 2 is a block diagram of a simplified illustrative control circuitry in accordance with this invention; and

FIG. 3 is a top or face view of the pager of FIG. 1 illustrating a typical display arrangement.

### DETAILED DESCRIPTION OF THE PREFERRED EMBODIMENT

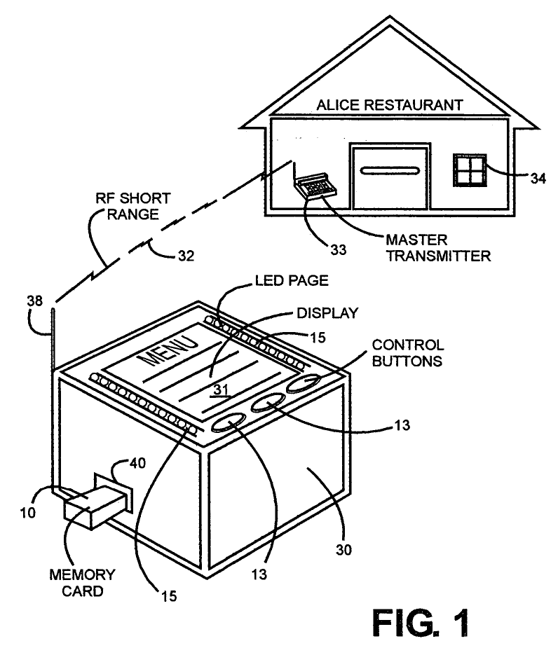

Referring to FIG. 1, there is a diagrammatic illustration of a restaurant paging system modified in accordance with the present invention. However, before proceeding with the description, some background on guest type paging systems would be appropriate. In such operations, the facility broadcasts a signal that triggers flashing lights and/or a buzzer in the receiver device telling the customer or client waiting in line that his turn has been reached. The facility broadcasts at a single frequency, but each individual pager has a specific identification sequence called a Channel Access Protocol (CAP) code. Each pager listens for its particular code in the broadcast. The pager alerts the user by beeping, flashing or buzzing. The on-site short range paging to which the present invention is addressed uses a small desktop short range RF transmitter. The individual pagers are battery run.

In the simplified illustration shown in FIG. 1, the set up at the restaurant is conventional, as described above. The master transmitter 33 in the restaurant 34 sends an appropriate RF short range signal to the selected guest pager that is received by antenna 38 in housing 30 and decoded to page the guest through LED (light emitting diode) page signals 15. While the user awaits such a page, the user may spend his time acquiring valuable information about the restaurant, its facilitates, foods, food preparation, staff branches, catering facilities, etc. In the illustrative example, the menu is shown. This aspect of the invention is made possible by the high capacity memory card 10, previously described, that is removably inserted into slot 40 in housing 30. These relatively high capacity (up to 4 gigabytes) can provide a substantial quantity of information. These memory cards are programmable so that the restaurant information may be upgraded on a daily basis. As set forth above, the memory cards may be a programmable memory card, such as a flash memory card or a memory stick popular with digital cameras. Very good results are achieved when the housing includes a USB I/O slot and the removable memory stick is inserted into said USB I/O slot. The screen may be any conventional LCD touch screen into which input may be applied through a finger or stylus, or the interaction with the display screen 31 may be through control buttons 13.

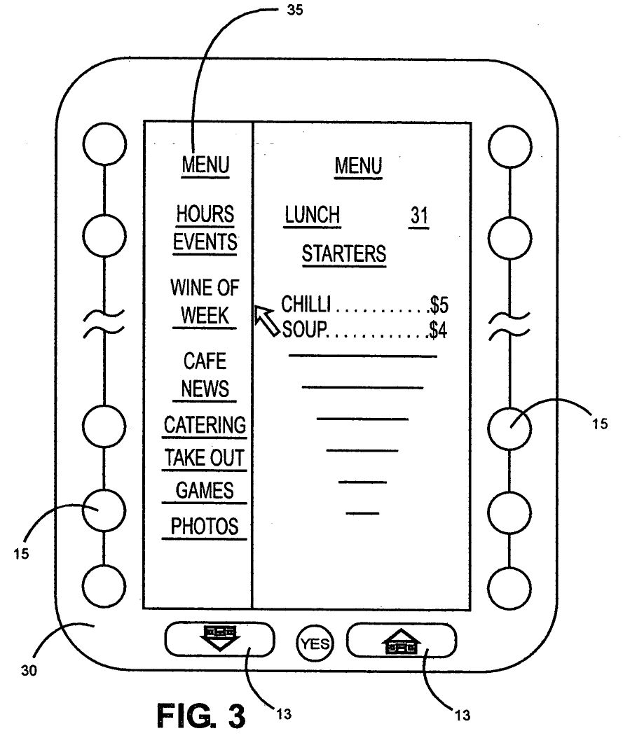

In FIG. 3 there is a face or top view of the pager display face wherein the elements are more distinctly shown. The restaurant menu is displayed, but side menu 35 shows other restaurant functions about which the user may get information while waiting, including restaurant hours, coming events, wine of the week, Cafe news, catering, availability of take out. Then there are items representing games that can be played or accessible photos.

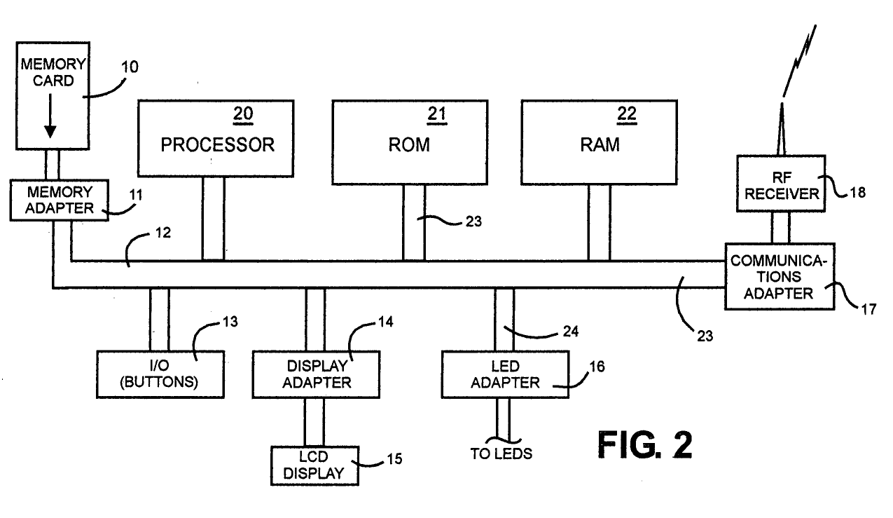

Now with reference to FIG. 2, the control system for the modified guest pager in accordance with the present invention may be embodied in the controller integrated circuit chips within the pager housing that provide specific purpose logic to control the access and logic as follows. These logic or control chips contain data processors 20, operating systems stored in RAM 22 (about 2 MB of RAM is provided) and a small ROM 21; the primary programmable memory is provided through memory card 10 connected to system bus 12 though memory adapter 11. This programmable ROM that may be an EEPROM, e.g. flash EEPROM 10. All of the routines and programs may also be conventionally stored in this flash EEPROM 21. These include memory card operating systems and built-in applications that may also be conventionally stored in the RAM. The logic or controller chip also contains the system bus 12 connected via Memory Adapter 11 at one end to the conventional connectors of the memory card 10 and at the other I/O end to a communication adapter 17 that, in turn, is connected to the RF receiver in the pager housing, as well as the LED flashers through an appropriate LED adapter. In accordance with the present invention, this relatively standard structure is modified to have an appropriate connection via display adapter to the LCD primary display 15. This system bus also connects the controlling processor 20 to the page signals, e.g. LEDs through LED adapter 16 and to I/O interactive buttons 13.

Although certain preferred embodiments have been shown and described, it will be understood that many changes and modifications may be made therein without departing from the scope and intent of the appended claims.

What is claimed is:

1. In a short range guest pager system including a localized short range RF transmitter and portable wireless receiving pager with an activatable page indicator, an implementation for providing the guest porting the pager with ancillary information comprising:
a pager housing supporting said indicator;
removable memory means in said housing storing said ancillary information;
a display in said housing;
interactive user input means to said pager for selectively activating the display of said ancillary information; and
display controller means in said housing for controlling said display of said ancillary information.

2. The short range guest pager system of claim 1 wherein said page indicator is a flasher.

3. The short range guest pager system of claim 1 wherein said display is a liquid crystal display.

4. The short range guest pager system of claim 3 wherein:
said liquid crystal display is a touch screen display; and
said interactive user input means is a touch input to said screen.

5. The short range guest pager system of claim 4 wherein said touch input is a stylus.

6. The short range guest pager system of claim 3 wherein said user interactive input means includes input buttons on said housing.

7. The short range guest pager system of claim 3 wherein said removable memory means is a programmable memory card.

8. The short range guest pager system of claim 7 wherein said programmable memory card is a flash memory card.

9. The short range guest pager system of claim 8 wherein said flash memory card is a memory stick.

10. The short range guest pager system of claim 9 wherein said housing includes a USB I/O slot and said removable memory stick is inserted into said USB I/O slot.

11. A portable wireless receiving guest pager with an activatable page indicator activatable by a localized short range wireless transmitter comprising:
a pager housing supporting a portable wireless activatable page indicator;
removable memory means in said housing storing ancillary information for a guest porting the pager;
a display in said housing;
interactive user input means to said pager for selectively activating the display of said ancillary information; and
display controller means in said housing for controlling said display of said ancillary information.

12. The portable wireless receiving guest pager of claim 11 wherein said page indicator is a flasher.

13. The portable wireless receiving guest pager of claim 11 wherein said display is a liquid crystal display.

14. The portable wireless receiving guest pager of claim 13 wherein:
said liquid crystal display is a touch screen display; and
said interactive user input means is a touch input to said screen.

15. The portable wireless receiving guest pager of claim 14 wherein said touch input is a stylus.

16. The portable wireless receiving guest pager of claim 13 wherein said user interactive input means includes input buttons on said housing.

17. The portable wireless receiving guest pager of claim 13 wherein said removable memory means is a programmable memory card.

18. The portable wireless receiving guest pager of claim 17 wherein said programmable memory card is a flash memory card.

19. The portable wireless receiving guest pager of claim 18 wherein said flash memory card is a memory stick.

20. The portable wireless receiving guest pager of claim 19 wherein said housing includes a USB I/O slot and said removable memory stick is inserted into said USB I/O slot.
